(19) United States
(12) Patent Application Publication
(10) Pub. No.: US 2010/0063687 A1
(43) Pub. Date: Mar. 11, 2010

(54) GPS DEVICE AND SAFE DRIVING METHOD USING THE SAME

(75) Inventors: HSIN-NAN HU, Tu-Cheng (TW); QING-LONG MA, Shenzhen City (CN); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/483,257

(22) Filed: Jun. 12, 2009

(30) Foreign Application Priority Data
Sep. 5, 2008 (CN) 200810304385.5

(51) Int. Cl. B60R 22/00

(52) U.S. Cl. 701/46

(57) ABSTRACT

This present disclosure provides a global positioning system (GPS) device, and a method of safe driving. The GPS device includes a storage unit, the storage unit configured to store map data and speed limit information of each speed limit section. Each speed limit information includes a speed limit start position, a speed limit end position, and a first predetermined speed value, the method includes steps of: receiving GPS satellite navigation signals in real time; detecting current location of a vehicle and determine whether the vehicle is in a speed limit section; detecting current speed value of the vehicle when the vehicle is in a speed limit section; generating and sending a control signal to control a safety protection unit to perform a safety protection operation, when the current speed value is greater than the first predetermined speed value in the speed limit section.

### BACKGROUND

1. Technical Field

The present disclosure relates to a global positioning system (GPS) device, and a method of safe driving using the GPS device.

2. Description of Related Art

Usually, vehicle navigation apparatus determines a current location of a vehicle using GPS data, and provides static information such as speed limits along chosen routes, gas station locations, known traffic speed monitoring locations etc. The apparatus may remind drivers to drive safely but GPS devices in vehicles rarely cooperate with traffic safety devices for helping the drivers to drive safely. For example, when the drivers are tired, distracted or drunken driving, the drivers could not easily reduce speed when meeting sharp turns, bridges, school area, and other special situations.

### BRIEF DESCRIPTION OF THE DRAWINGS

The components in the drawings are not necessarily drawn to scale, the emphasis instead being placed upon clearly illustrating the principles of the GPS device and the method of safe driving. Moreover, in the drawings, like reference numerals designate corresponding parts throughout the several views.

FIG. 1 is a block diagram of a hardware infrastructure of a GPS device with a safety protection unit, in accordance with an exemplary embodiment.

FIG. 2 is a block diagram showing more functional modules of a central processing unit (CPU) of a GPS device of FIG. 1, in accordance with an exemplary embodiment.

FIG. 3 is a flowchart of method of safe driving implemented by the GPS device of FIG. 1, in accordance with an exemplary embodiment.

FIG. 4 is a flowchart of a safety protection process implemented by the GPS device of FIG. 1, in accordance with an exemplary embodiment.

FIG. 5 is a flowchart of a speed limit prompt process implemented by the GPS device of FIG. 1, in accordance with an exemplary embodiment.

### DETAILED DESCRIPTION OF THE EMBODIMENTS

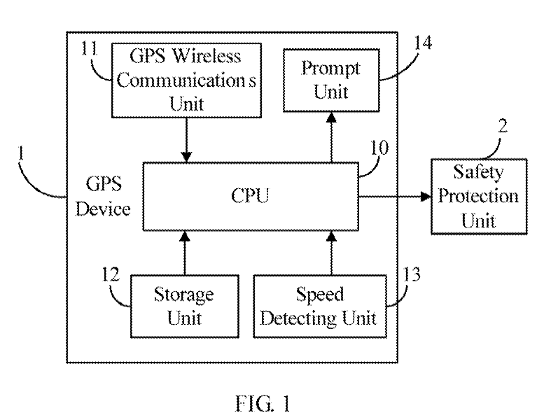

Referring to FIG. 1, a GPS device 1 and a safety protection unit 2 are disclosed.

The safety protection unit 2 is configured to receive control signals from the GPS device 1 and perform a safety protection operation, the safety protection operation includes, but is not limited to, reminding and warning, let up on gas, stopping rotation of wheels. The safety protection unit 2 may be, for example, but is not limited to, a prompt device, an electromagnetic valve for controlling a throttle, or a brake apparatus.

The GPS device 1 includes a central processing unit (CPU) 10, a GPS wireless communications unit 11, a storage unit 12, a speed detecting unit 13, and a prompt unit 14.

The GPS wireless communications unit 11 is configured to receive GPS satellite navigation signals in real time, and transmit the navigation signals to the CPU 10. The storage unit 12 is configured to store map database information, the map database information includes map data and other additional information data such as speed limit information of each speed limit section. The speed detecting unit 13 is configured to detect current speed signals of a vehicle and transmit the detected signals to the CPU 10. The prompt unit 14 may be, for example, but is not limited to, a speaker, or an indicator lamp. When the prompt unit 14 is a speaker, the speaker could output a predetermined audio file which is saved in the storage unit 12 such as “speeding is dangerous, slow down, please!” When the prompt unit 14 is an indicator lamp, the indicator lamp could flash to respond to the control signals to remind the drivers safe driving.

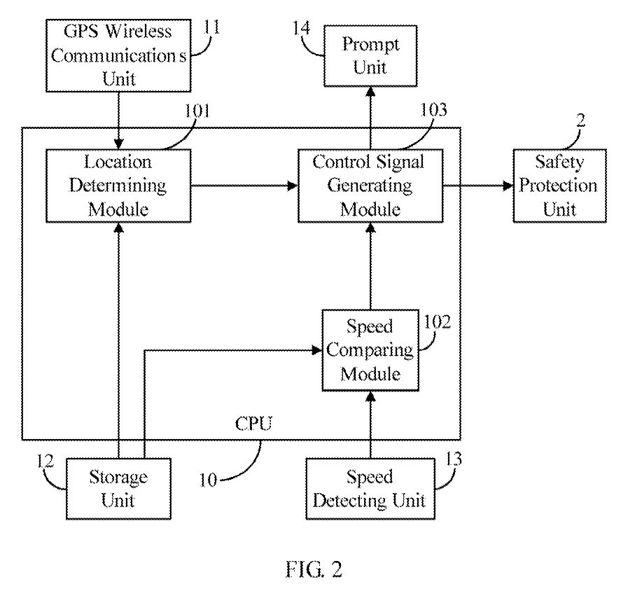

Referring to FIG. 2, the CPU 10 includes a location determining module 101, a speed comparing module 102, a control signal generating module 103.

The location determining module 101 is configured to determine current location according to the navigation signals from the GPS wireless communications unit 11, and further determine whether the vehicle is in a speed limit section according to a result of comparing the current location with a speed limit start position and a speed limit end position in the storage unit 12.

Each speed limit information includes a speed limit start position, a speed limit end position, and a first predetermined speed value. The speed limit start position is defined as a start position of the speed limit section, such as a turn start position, a start position of a bridge, a start position of a construction section, or a start position of a tunnel. The speed limit end position is defined as an end position corresponding to the speed limit section. The first predetermined speed value is defined as a maximum value that is permitted for a vehicle to pass through the speed limit section.

The speed comparing module 102 is configured to analyze the detected signals from the speed detecting unit 13 to filter out noise and obtain a current speed value of the vehicle, and compare the current speed value with the first predetermined speed value in the storage unit 12. The control signal generating module 103 is configured to generate and send a control signal to the safety protection unit 2, the safety protection unit 2 performs the safety protection operation when the vehicle is in the speed limit section and the current speed value is greater than the first predetermined speed value. The storage unit 12 is connected with the location determining module 101 and the speed comparing module 102, and provides the speed limit information.

The GPS device 1 includes at least one prompt unit 14 as shown in FIG. 1. Each speed limit information also includes a prompt location of limiting speed, and a second predetermined speed value. The prompt location of limiting speed is defined as a location having a predetermined distance from the speed limit section. The second predetermined speed value is defined as a maximum value that is permitted the vehicle arrives at the prompt location of limiting speed. The location determining module 101 is also configured to determine whether the vehicle arrives at the prompt location of limiting speed, and a judgment is according to a result of comparing the current location with the prompt location of limiting speed in the storage unit 12. The speed comparing module 102 is also configured to compare the current speed value with the second predetermined speed value in the storage unit 12. The control signal generating module 103 is also configured to generate and send another control signal to the prompt unit 14, the prompt unit 14 performs a prompt process of limiting speed when the vehicle arrives at the prompt location of limiting speed and the current speed value is greater than the second predetermined speed value.

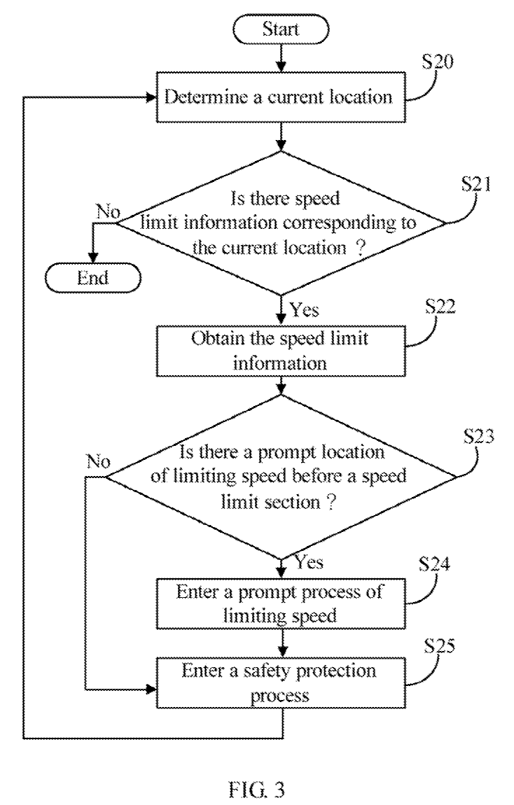

FIG. 3 is a flowchart of method of safe driving implemented by the GPS device of FIG. 1, in accordance with an exemplary embodiment.

In step S20, the location determining module 101 determines the current location of the vehicle according to the navigation signals received by the GPS wireless communications unit 11.

In step S21, the location determining module 101 determines whether there is speed limit information corresponding to the current location. If yes, then the procedure goes to step 22; if not, the procedure ends.

In step S22, the CPU 10 obtains the speed limit information in the storage unit 12.

In step S23, the location determining module 101 determines whether the speed limit information includes a prompt location of limiting speed before the speed limit section. If yes, then the procedure goes to step 24, if not, the procedure goes to step 25.

In step S24, the procedure enters a prompt process of limiting speed.

In step S25, the procedure enters a safety protection process.

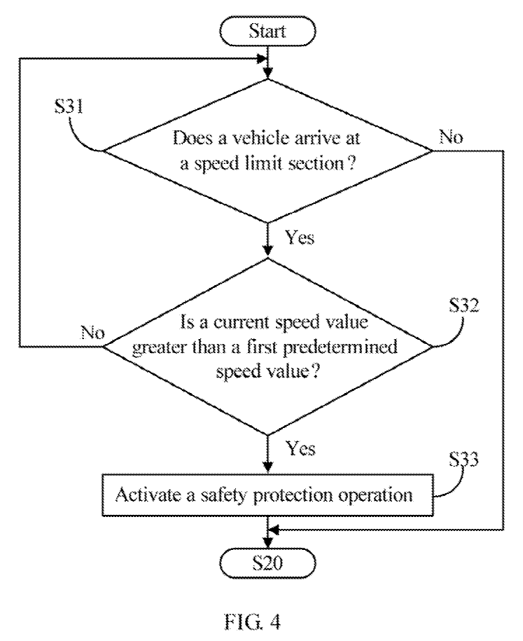

FIG. 4 is a flowchart of a safety protection process implemented by the GPS device of FIG. 1, in accordance with an exemplary embodiment.

In step S31, the location determining module 101 compares the current location with the speed limit start position and the speed limit start position to determine whether the vehicle is in the speed limit section. If yes, the procedure goes to S32, if not, the procedure returns to S20.

In step S32, the speed comparing module 102 compares the current speed value with the first predetermined speed value in the storage unit 12. When the current speed value is greater than the first predetermined speed value, the procedure goes to S33, if not, the procedure returns to S31.

In step S33, the corresponding safety protection unit 2 receives a control signal from the control signal generating module 103, and performs the safety protection operation. When the safety protection operation ends, the procedure returns to S20.

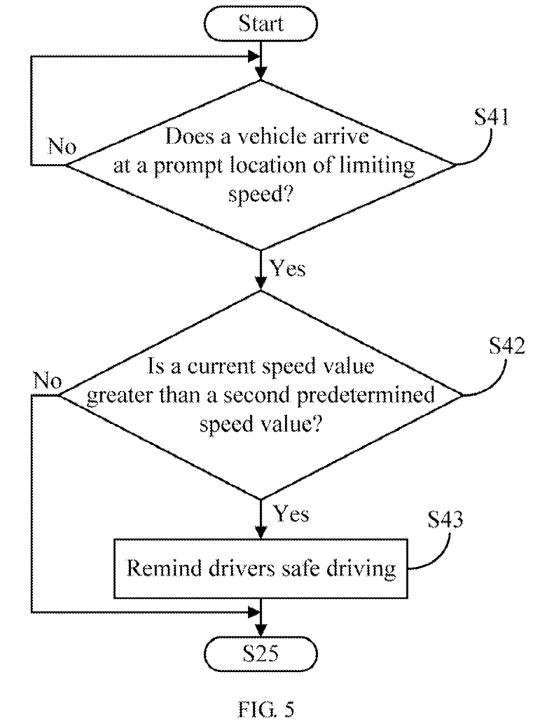

FIG. 5 is a flowchart of a speed limit prompt process implemented by the GPS device of FIG. 1, in accordance with an exemplary embodiment.

In step S41, the location determining module 101 compares the current location with the prompt location of limiting speed to determines whether the vehicle arrives at the prompt location of limiting speed in real time. If yes, the procedure goes to S42, if not, the procedure repeats the step S41.

In step S42, the speed comparing module 102 compares the current speed value with the second predetermined speed value in the storage unit 12. When the current speed value is greater than the second predetermined speed value, the procedure goes to S43, if not, the procedure goes to S25.

In step S43, the corresponding prompt unit 14 receives a control signal from the control signal generating module 103, and performs the prompt process of limiting speed to remind drivers of safe driving.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A global position system (GPS) device comprising:
a GPS wireless communications unit configured to receive GPS satellite navigation signals in real time;
a storage unit configured to store map database information, the map database information comprising map data and speed limit information of each speed limit section, each speed limit information comprising a speed limit start position, a speed limit end position, and a first predetermined speed value;
a location determining module configured to determine whether the vehicle is in a speed limit section according to the GPS navigation signals and the map database information stored in the storage;
a speed comparing module configured to obtain a current speed value of the vehicle from a speed detecting unit when the vehicle is determined to be in a speed limit section by the location determining module, and compare the current speed value with the first predetermined speed value corresponding to the speed limit section;
a control signal generating module configured to generate and send a control signal to a safety protection unit when the current speed value is determined to be greater than the first predetermined speed value by the speed comparing module, the safety protection unit being configured to perform a safety protection operation according to the control signal.

2. The GPS device as described in claim 1, further comprising at least one prompt unit, wherein the speed limit information further comprises a prompt location of limiting speed, and a second predetermined speed value, and the location determining module is further configured to determine whether the vehicle is at a prompt location of limiting speed, the speed comparing module is further configured to obtain a current speed value of the vehicle when the vehicle is determined to be at a prompt location of limiting speed by the location determining module, the control signal generating module is further configured to generate and send another control signal to control the prompt unit to remind drivers of safe driving when the current speed value is greater than the second predetermined speed value.

3. The GPS device as described in claim 2, wherein the prompt unit is a speaker, the speaker outputs a predetermined audio file to remind drivers of safe driving.

4. The GPS device as described in claim 2, wherein the prompt unit is an indicator lamp, the indicator lamp flashes to respond to the control signals from the control signal generating module to remind drivers of safe driving.

5. A method of safe driving of vehicles by employing a global position system (GPS) device, the GPS device comprising a storage unit, the storage unit being configured to store map database information, the map database information comprising map data and speed limit information of each speed limit section, each speed limit information comprising a speed limit start position, a speed limit end position, and a first predetermined speed value, the method comprising:
receiving GPS satellite navigation signals in real time;
detecting current location of a vehicle and determining whether the vehicle is in a speed limit section according to the GPS satellite navigation signals and the map database information stored in the storage;
detecting current speed value of the vehicle when the vehicle is in a speed limit section; and
generating and sending a control signal to control a safety protection unit to perform a safety protection operation, when the current speed value of the vehicle is greater than the first predetermined speed value in the speed limit section.

6. The method as described in claim 5, wherein the speed limit information further comprises a prompt location of limiting speed, a second predetermined speed value, the method further comprising:
determining whether the vehicle is at the prompt location of limiting speed;
detecting current speed value of the vehicle when the vehicle is at the prompt location of limiting speed; and
generating and sending a control signal to control a prompt unit to remind drivers of safe driving, when the current speed value of the vehicle is greater than the second predetermined speed value at the prompt location of limiting speed.
